(19) United States
(12) Patent Application Publication
(10) Pub. No.: US 2025/0229694 A1
(43) Pub. Date: Jul. 17, 2025

(54) WORKING EQUIPMENT ASSEMBLY

(71) Applicant: Hiab AB, Malmö (SE)

(72) Inventor: Ville VÄHÄ-PIIKKIÖ, Rusko (FI)

(73) Assignee: Hiab AB, Malmö (EP)

(21) Appl. No.: 18/985,213

(22) Filed: Dec. 18, 2024

(30) Foreign Application Priority Data
Dec. 20, 2023 (EP) 23218528.0

(51) Int. Cl. B60P 1/48

(52) U.S. Cl. CPC B60P 1/483

(57) ABSTRACT

A working equipment assembly arranged to be mounted to a vehicle. The working equipment assembly includes a lift-frame connection arrangement including connection 5 lines adapted to connect control and operating systems to the lift-frame, and an elongated rigid structure configured to guide, protect and at least partly enclose the connection lines over a predetermined length. The rigid structure is pivotably attached to the vehicle by a connection joint at a connection attachment position, and the connection attachment position is close to, and within a predetermined distance from, the arm attachment 10 position, so that the elongated rigid structure is arranged to follow the movement of the movable arm, when the working equipment is operated in the lift-frame mode, and structured to stow at least a part of the connection lines along the longitudinal axis A of the vehicle when the working equipment is operated in the attachment member mode.

This application claims priority to European Application No. 23218528.0, filed Dec. 20, 2023, which is hereby incorporated herein by reference in its entirety.

### TECHNICAL FIELD

The present disclosure relates to a working equipment assembly, particularly a working equipment being a hooklift, and comprising a so-called lift-frame applied to be connected to load carrying objects, e.g. ISO 668 containers.

### BACKGROUND

Lift-frames applied in connection with hooklifts are disclosed in the following documents. US2023/0331135 that relates to a loading arrangement for loading and unloading load units on and off a vehicle comprises a frame to be fastened to the vehicle in a detachable manner.

EP4282707 relates to a working equipment with a lift frame assembly with alignment capabilities.

Presently applied lift-frames are mainly manually operated. One reason for this is that the routing of hoses, electricity and/or pneumatics is quite complicated to bring to the tip of the hooklift arm. Also, the lift-frame is typically detachable from the gripping hook, which also requires some kind of quick couplings to disconnect the lines to allow uses not applying the lift-frame, e.g. for loading/unloading a flatrack having an integrated bar that the hook can attach to.

One possibility could be to arrange a separate hydraulic system, or electrical system, at the lift-frame for controlling and operating the actuators and connectors of the lift-frame. However, this is not advantageous as it adds on complexity and weight to the lift-frame.

The object of the present invention is to achieve an improved working equipment, e.g. a hooklift, to be connected to a lift-frame, without having to manually connect and disconnect connection lines to the lift-frame when the lift-frame is to be used, and where no separate hydraulic or electrical system is required to be installed at the lift-frame.

### SUMMARY

The above-mentioned objects are achieved by the present invention according to the independent claim.

Preferred embodiments are set forth in the dependent claims.

According to the invention, the connection lines including e.g. hydraulic, pneumatic and/or electrical lines, are connected to the lift-frame all the time, both during operations in a lift-frame mode when the lift-frame is attached to the hooklift arm, and operations in an attachment member mode when the lift-frame not is attached to the hooklift arm, but instead is stowed at the vehicle. A lift-frame connection arrangement is provided, comprising the connection lines, adapted to connect control and operating systems of the working equipment, i.e. the hooklift equipment, to the lift-frame, and an elongated rigid structure configured to guide, protect and at least partly enclose the connection lines over a predetermined length. The rigid structure is pivotably attached to the vehicle by a connection joint at a connection attachment position. The elongated rigid structure is arranged to follow the movement of the movable arm, when the working equipment is operated in the lift-frame mode, and structured to stow at least a part of the connection lines along the longitudinal axis A of the vehicle when the working equipment is operated in the attachment member mode.

By applying the present invention, there is no need to use any connectors or couplings that need to be manually attached and deattached to the lift-frame depending on the operating mode of the working equipment. The connection lines are prevented from interfering with the lift-frame and getting entangled in the working equipment and/or vehicle when the lift-frame is used, and remain stowed outside the movement range of the hooklift, when the lift-frame not is used.

Because the connection lines are connected to the lift-frame all the time, new functions may be provided on the lift-frame.

### BRIEF DESCRIPTION OF THE DRAWINGS

FIG. 1 is a schematic side view of a vehicle provided with a working equipment assembly as disclosed herein in a lift-frame mode but without any container loaded to the load bed of the vehicle.

FIG. 2 is a schematic view from above of a vehicle provided with a working equipment assembly as disclosed herein in a lift-frame mode.

FIGS. 3-6 are schematic side views of a vehicle provided with a working equipment assembly as disclosed herein in a lift-frame mode, during various parts of a loading procedure.

FIG. 7 is a schematic side view of a vehicle provided with a working equipment assembly as disclosed herein in an attachment member mode.

### DETAILED DESCRIPTION

The working equipment assembly will now be described in detail with references to the appended figures. Throughout the figures the same, or similar, items have the same reference signs. Moreover, the items and the figures are not necessarily to scale, emphasis instead being placed upon illustrating the principles of the invention.

With references to the figures, a working equipment assembly 2 is provided, arranged to be mounted to a vehicle 4, e.g. a loader vehicle, such as a truck for transporting ISO containers and flat racks, or other load carrying objects.

The working equipment assembly 2 comprises a working equipment 6 comprising a hooklift that in turn comprises a movable arm 8 for loading and unloading a load carrying object 10, such as a container, or a flat-rack container, to/from the vehicle 4.

The movable arm 8 has a first end pivotably mounted to the vehicle at an arm attachment position 12, and a second end provided with an attachment member 14, e.g. a hook, arranged to connect the movable arm 8 to the load carrying object 10 during the loading or unloading, when the working equipment 6 is operated in an attachment member mode.

The attachment member 14 is also arranged to connect the movable arm 8 to a lift-frame 16. The lift-frame, being part of the working equipment assembly 2, comprising an attachment part 18, such as a bar, arranged to be attached to the attachment member 14, e.g. the hook, and a set of connectors arranged to connect the lift-frame 16 to the load carrying object 10 during loading and unloading. The working equipment 6 is operated in a lift-frame mode, when the attachment member 14 is attached to the lift-frame 16. It is particularly advantageous to apply a lift-frame during loading and unloading of ISO 668 containers. ISO 668 containers belong to a series of freight containers having standardized dimensions and having a standard that regulates both external and internal dimensions of containers, as well as the minimum door opening sizes, where applicable. A lift-frame 16 disclosed herein is provided with a set of connectors adapted to attach the lift-frame to standardized openings provided e.g. at the edges of the container, thereby achieving a controlled loading and unloading procedure of the container to and from the vehicle.

There are further other alternative lift-frames used for loading and unloading other types of load carrying objects. One alternative example may be a lift-frame for loading and unloading bridge adapter pallets that are used to build bridges and in use in defence and/or rescue applications. In this particular lift-frame for bridge transports a hydraulic winch is commonly used as a connector on the lift-frame to connect to the bridge adapter pallet to be loaded or unloaded.

The working equipment assembly 2 further comprises a lift-frame connection arrangement 20 comprising connection lines 22, e.g. hydraulic lines, pneumatic lines, or electrical lines, adapted to connect control and operating systems of the working equipment 6 to the lift-frame 16. The connection lines comprise necessary lines for controlling the various functions of the lift-frame, e.g. for controlling the set of connectors, which may be hydraulically controlled via hydraulic lines. In addition, various sensors may be provided at the lift-frame which require electrical power, and electrical communication of e.g. measurement values.

The lift-frame connection arrangement 20 further comprises an elongated rigid structure 24 configured to guide, protect and at least partly enclose the connection lines 22 over a predetermined length. In one embodiment the elongated rigid structure 24 is arranged to be integrated with the connection lines 22 as one or more pipe or tube of predetermined length that is then connected to at least one flexible hose or cable for further connection to the lift-frame. The rigid structure 24 is pivotably attached to the vehicle 4 by a connection joint 26 at a connection attachment position 28. Preferably, the rigid structure is pivotable about an axis perpendicular to a longitudinal axis A of the vehicle.

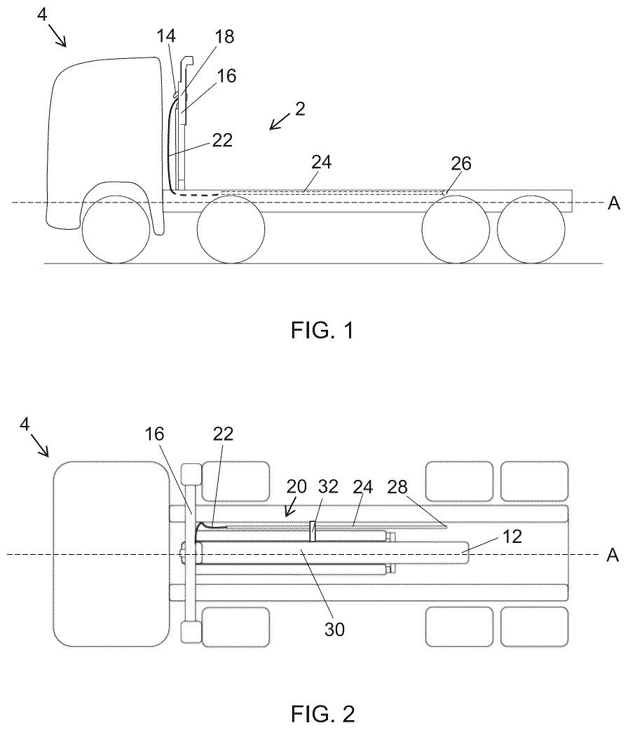

The connection attachment position 28 is close to, and within a predetermined distance from, the arm attachment position 12, so that the elongated rigid structure 24 is arranged to follow the movement of the movable arm 8, when the working equipment 6 is operated in the lift-frame mode. FIGS. 1-6 illustrate the working equipment operated in the lift-frame mode.

The elongated rigid structure 24 is furthermore structured to stow at least a part of the connection lines 22 along the longitudinal axis A of the vehicle 4 when the working equipment 6 is operated in the attachment member mode. It may hence stow at least a part of the connection lines 22 along the longitudinal axis A of the vehicle 4, preferably from the connection attachment position 28 to the lift-frame 16 when the working equipment 6 is operated in the attachment member mode. FIG. 7 illustrates the working equipment operated in the attachment member mode.

In a further variation, when using an alternative lift-frame for bridge adapter pallets, the lift-frame may be completely unloaded when in the attachment member mode. However, the connection lines will then still be stowed along the longitudinal axis of the vehicle to a connection point behind the cab of the vehicle.

In one embodiment of the working equipment assembly 2, the lift-frame connection arrangement 20 is pivotable from a position where it is oriented in a forward direction of the vehicle 4 along the longitudinal axis A of the vehicle 4 (see e.g. FIGS. 1 and 2), to a 25 position where it is oriented essentially along a middle frame 30 of the movable arm 8, and inclined in a backward direction of the vehicle 4 (see FIGS. 4 and 5).

The lift-frame connection arrangement 20 may be pivotable in a virtual vertical plane being essentially parallel to a virtual movement plane of the movable arm, provided that the vehicle 4 is operated on a horizontally oriented ground. In an alternative embodiment the lift-frame connection arrangement 20 is pivotable in a virtual vertical plane being arranged at an angle (e.g. in the range of 1-10 degrees) to a virtual movement plane of the movable arm, this would enable the lift-frame connection arrangement 20 to move further away from the center of the lift-frame 16 when it is in a rearward direction, to further avoid risk of collisions between the connection lines and part of the working equipment and vehicle.

In FIG. 1, the attachment member 14, being a hook in the illustrated example, is attached to the attachment part 18 of the lift-frame 16. The attachment part 18 may be a horizontal bar.

According to an embodiment, the predetermined distance between the connection attachment position 28 of the lift-frame connection arrangement 20, and the arm attachment position 12 of the movable arm 8 is less than 1 meter, and preferably less than 0.5 meter, or in an even more preferred embodiment, less than 25 cm. The connection attachment position 28 of the lift-frame connection arrangement 20 is located essentially at the same longitudinal position as, or in front of, the arm attachment position 12 of the movable arm 8, along, or parallel to, the longitudinal axis A of the vehicle 4.

According to a further embodiment, the working equipment assembly 2 comprises at least one movement restriction member 32 structured to prevent the rigid structure 24 of the lift-frame connection arrangement 20 of passing by a middle frame 30 of the movable arm 8 in a backward direction of the vehicle 4 along the longitudinal axis A of the vehicle 4 during movement of the movable arm 8 when the hooklift is operated in the lift-frame mode, thus preventing interference with said lift-frame 16 attached to the attachment member 14, i.e. the hook, and/or the vehicle, and/or parts of the working equipment. This embodiment is clearly illustrated in FIGS. 4 and 5, where the movement restriction member 32 prevents the rigid structure 24 passing by the middle frame, and thus preventing the connection lines, e.g. from falling down against the vehicle, and from being too close to movable parts of the lift-frame, where there is a risk of compromising the loading/unloading procedure.

According to a further embodiment the pivoting axles of the movable arm 8 at arm attachment position 12 and the elongated rigid structure 24 connection attachment position 28 are arranged in line, or essentially in line, with each other, enabling the movement restriction member to clamp and/or attach to the elongated rigid structure 24 when in lift-frame mode and detach from the elongated rigid structure 24 when in attachment member mode.

The movement restriction member 32 may in this case comprise an additional actuator to attach and detach the elongated rigid structure 24 in dependence of the mode being active. In a further embodiment, the movement restriction member 32 is at least one bar and/or roller, and/or steel structure, and/or plate, mounted on the rigid structure 24 of the lift-frame connection arrangement 20, and/or at the middle frame 30 of the movable arm 8, which is illustrated by the figures.

According to another embodiment, the rigid structure 24 is a tube, a hollow beam, or another type of enclosure capable of receiving, enclosing, and protecting the connection lines arranged within the rigid structure 24.

The rigid structure 24 may in an alternative embodiment comprise a bundle of pipes or tubes that further serves as connection lines and that are clamped or packaged together, and hence forming the rigid structure. Flexible hoses and/or cables may further be attached and connected to the bundle of pipes to complete the connection of the connection lines to the lift-frame.

Preferably, the rigid structure is made from a steel-structure, and/or a light-weight material, e.g. aluminium, or any alloy, plastic, carbon fibre materials, etc. The rigid structure may e.g. comprise a pattern, e.g. of holes, to reduce the weight of the structure.

The predetermined length of the rigid structure 24 may be related to the length of a middle frame 30 of the movable arm 8 such that the lengths do not differ more than 20%. The predetermined length of the rigid structure 24 may further be related to the geometry of the working equipment such as the relation between a stowed position of the lift-frame, a horizontal movement of the tip of the movable arm and/or the length of the middle beam 30.

In still another embodiment, the lift-frame 16, when not in use loading or unloading operation, is structured to be stored at the vehicle 4, behind a cabin of the vehicle 4, and in front of the movable arm 8. This is illustrated in FIGS. 2 and 7; FIG. 2 shows the lift-frame attached to the hooklift arm in the stored position, and FIG. 7 shows the lift-frame in the stored position while operating the working equipment in attachment member mode. In one alternative embodiment the lift-frame 16 may be unloaded from the vehicle and working equipment when not in use for loading or unloading operation with the lift-frame 16. The lift-frame 16 is then parked at a position on the ground or a separate arrangement stationary on the ground. In such an embodiment the connection lines 22 are first disconnected from the lift-frame 16 in the stowed position for attachment member mode. The lift-frame connection arrangement 20 may hence enable safe operation of the working equipment in attachment member mode even if the lift-frame is disconnected and parked away from the vehicle.

The operating procedures of the working equipment assembly will now be described with references to the figures.

In the side view of the vehicle, shown in FIG. 1, the working equipment is in a lift-frame mode, where the hooklift is attached to the lift-frame 16. The lift-frame is stowed behind the cabin of the vehicle. The connection lines 22 are connected to the lift-frame, and the rigid structure 24 is stowed in a forward direction, parallel to the longitudinal axis A of the vehicle.

FIG. 2 shows a view from above of the vehicle shown in FIG. 1. In particular, the movement restriction member 32 is shown, and also two hydraulic cylinders located on each side of the middle beam 30 of the moveable arm. These hydraulic cylinders are used to apply movement to the movable arm.

In FIG. 2 is shown an embodiment of the invention where the rigid structure 24 is arranged parallel to the middle beam 30, and to the outer side of one of the two hydraulic cylinders for the moveable arm. In alternative embodiments the rigid structure 24 may be arranged at an angle to the longitudinal axis A of the vehicle, to allow for the rigid structure to slightly point away from the center when the lift-frame is at its rear position for loading or unloading. This embodiment may further reduce the risk of the connection lines colliding with other parts of the working equipment assembly. In further alternative embodiments the rigid structure 24 may be arranged under the middle beam 30. And in yet another embodiment the rigid structure 24 may be arranged at the outer side of a chassis of the vehicle, or a sub frame of the working equipment, assembly. In this embodiment an actuator or spring element may be arranged at the connection attachment position 28 to further support the movement of the rigid structure 24. An actuator or spring element may further be arranged at the connection attachment position 28 to support the movement of the rigid structure 24 in any of the other embodiments.

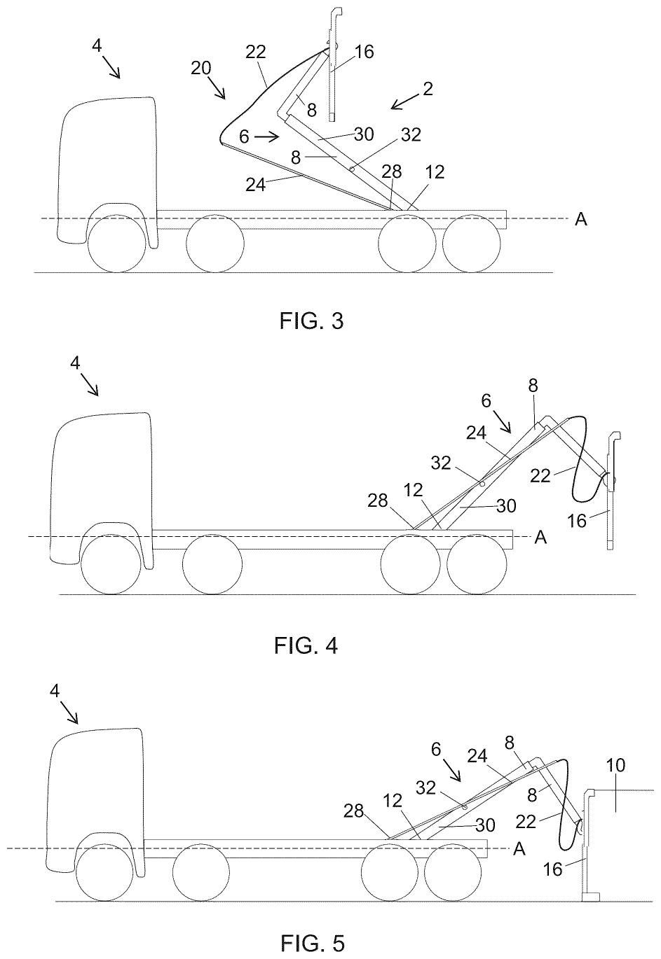

In the side view shown in FIG. 3, the moveable arm 8 has been moved approximately 45 degrees from its original position by movement forces applied to the movable arm by the hydraulic cylinders (not shown in FIG. 3). The connection lines, being flexible from the attachment point to the lift-frame to the end of the rigid structure 24, will lift the rigid structure 24 such that it follows the movement of the movable arm.

In FIG. 4, the movable arm 8 has reached a position of approximately 135 degrees from its original position. In particular, when moving past 90 degrees, i.e. when the middle frame 30 is directed upwards, the rigid structure 24 will follow the movement and be restricted by the movement restriction member 32 from passing by the movable arm 8 to a position where the connection lines 22 will interfere with the lift-frame 16.

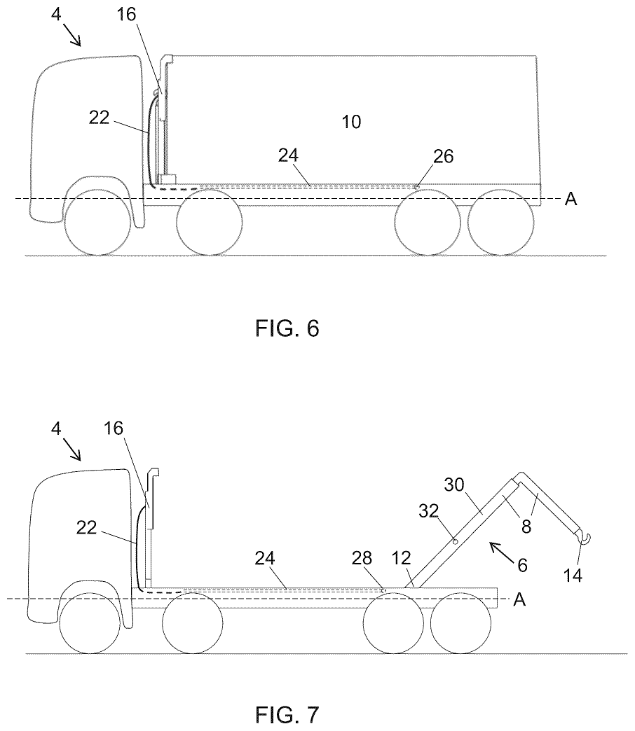

In FIG. 5, the lift-frame has been attached to a container 10 by means of the set of connectors provided at the lift-frame, and in FIG. 6 the container has been loaded onto the vehicle, and the rigid structure 24 has also been moved to its stowed position.

In FIG. 7, the hooklift is instead used in the attachment member mode, where the hook may be directly applied for lifting e.g. a container. In this mode, i.e. the hooklift is not attached to the lift-frame, the lift-frame is stowed behind the cabin, and the connection lines 22 are attached to the lift-frame.

The present invention is not limited to the above-described preferred embodiments. Various alternatives, and modifications may be used. Therefore, the above embodiments should not be taken as limiting the scope of the invention, which is defined by the appending claims.

1. A working equipment assembly arranged to be mounted to a vehicle, the working equipment comprises a hooklift comprising a movable arm for loading and unloading a load carrying object, such as a container, to/from the vehicle, the movable arm has a first end pivotably mounted to said vehicle at an arm attachment position and a second end provided with an attachment member, e.g. a hook, arranged to connect the movable arm to the load carrying object during the loading or unloading wherein said working equipment is operated in an attachment member mode, or to a lift-frame, wherein the lift-frame, being part of said working equipment assembly, comprising an attachment part arranged to be attached to said attachment member, and a set of connectors arranged to connect the lift-frame to the load carrying object during loading and unloading, and wherein said working equipment is operated in a lift-frame mode, when said attachment member is attached to said lift-frame, wherein the working equipment assembly further comprises a lift-frame connection arrangement comprising connection lines, e.g. hydraulic lines, pneumatic lines, or electrical lines, adapted to connect control and operating systems of the working equipment to the lift-frame, and an elongated rigid structure configured to guide, protect and at least partly enclose said connection lines over a predetermined length, wherein the rigid structure is pivotably attached to the vehicle by a connection joint at a connection attachment position, and said connection attachment position is close to, and within a predetermined distance from, said arm attachment position, so that the elongated rigid structure is arranged to follow the movement of the movable arm, when the working equipment is operated in the lift-frame mode, and structured to stow at least a part of the connection lines along a longitudinal axis A of the vehicle when the working equipment is operated in the attachment member mode.

2. The working equipment assembly according to claim 1, wherein said lift-frame connection arrangement is pivotable about an axis perpendicular to the longitudinal axis A of the vehicle.

3. The working equipment assembly according to claim 1, wherein said lift-frame connection arrangement is pivotable from a position where it is oriented in a forward direction of the vehicle along said longitudinal axis A of the vehicle, to a position where it is oriented essentially along a middle frame of said movable arm, and inclined in a backward direction of the vehicle.

4. The working equipment assembly according to claim 1, wherein said predetermined distance is 1 meter, and more preferred 0.5 meter, and most preferred 0.25 meter, and that said connection attachment position of the lift-frame connection arrangement is located essentially at the same longitudinal position as, or in front of, said arm attachment position of the movable arm, along said longitudinal axis A of the vehicle.

5. The working equipment assembly according to claim 1, comprising a movement restriction member structured to prevent the rigid structure of said lift-frame connection arrangement of passing by a middle frame of the movable arm in a backward direction of said vehicle along the longitudinal axis A of the vehicle during movement of the movable arm when said hooklift is operated in the lift-frame mode, thus preventing interference with said lift-frame attached to said attachment member, i.e. the hook.

6. The working equipment assembly according to claim 5, wherein said movement restriction member is at least one bar, and/or roller, and/or steel structure, and/or plate, mounted on said rigid structure of the lift-frame connection arrangement, and/or at said middle frame of the movable arm.

7. The working equipment assembly according to claim 1, wherein the rigid structure is a tube, or a hollow beam, made from a light-weight material.

8. The working equipment assembly according to claim 1, wherein said lift-frame, when not in use, is structured to be stored at the vehicle, behind a cabin of the vehicle, and in front of said movable arm.
